(19) United States
(12) Patent Application Publication
(10) Pub. No.: US 2010/0135172 A1
(43) Pub. Date: Jun. 3, 2010

(54) METHOD AND APPARATUS FOR PREDICTING CHANNEL QUALITY INDICATOR IN A HIGH SPEED DOWNLINK PACKET ACCESS SYSTEM

(75) Inventors: Tao Cui, Santa Clara, CA (US); Feng Lu, Sunnyvale, CA (US); Anil Kumar Goteti, Evanston, IL (US); Vignesh Sethuraman, Milpitas, CA (US); Subramanya P. Rao, Santa Clara, CA (US); Parvathanathan Subrahmanya, Sunnyvale, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/554,202

(22) Filed: Sep. 4, 2009

Related U.S. Application Data
(60) Provisional application No. 61/095,270, filed on Sep. 8, 2008.

(51) Int. Cl. H04L 12/26

(52) U.S. Cl. 370/252

(57) ABSTRACT

Various embodiments are disclosed which predict the channel quality indicator (CQI) in High Speed Downlink Packet Access (HSDPA). The accuracy of CQI is crucial for HSDPA performance. In some HSDPA systems the CQI may be as much as three (3) subframes stale. Accordingly, the prediction of CQI values is required in order to efficiently schedule data for transmission over the communication channel. Various embodiments disclose first order adaptive IIR filters which are significantly less complex than the finite impulse response (FIR) counterparts and achieve similar accuracy. By minimizing the mean squared error (MSE), an exact gradient descent algorithm may be used as well as two embodiment pseudolinear regression algorithms.

### RELATED APPLICATIONS

The present Application for Patent claims the benefit of priority to Provisional Application No. 61/095,270 entitled “HSDPA CQI Predictive Filter” filed Sep. 8, 2008, and to Provisional Application No. 61/097,848 entitled “First Order Adaptive IIR Filter for CQI Prediction in HSDPA” filed Sep. 17, 2008, both of which are assigned to the assignee hereof and hereby expressly incorporated by reference herein.

### FIELD

The present invention relates generally to wireless communication technologies, and more particularly to a system and method for predicting the quality of a channel supporting High Speed Downlink Packet Access for data communication.

### BACKGROUND

High-Speed Downlink Packet Access (HSDPA) is a part of the third generation (3G) mobile telephony communications protocol. It is considered by some to be an enhanced 3G mobile telephony communications protocol in the High-Speed Packet Access (HSPA) family, also coined 3.5G or 3G+. HSDPA allows networks based on Universal Mobile Telecommunications Systems (UMTS) to have higher data transfer speeds and capacity. Communication over a HSDPA system occurs between a base station and a plurality of mobile user equipment (UE) stations, also referred to as mobile devices.

NOM One feature of HSDPA is the ability to adapt the data communication rate in accordance with the relative strength of the communication signal channel supporting the communication. Typically, a HSDPA system will obtain an indicator of the relative channel signal strength and arrange the data packets in a manner reflective of the relative channel signal strength. Accordingly, it is vital that the indicator of relative channel signal strength accurately reflect the channel signal strength at the time of transmission in order to effectively arrange the data packets. In most HSDPA systems, however, there is a delay between the time an indicator of relative channel signal strength is obtained and the time that data packets are actually transmitted. Changes in the channel signal strength during this delay period may negatively impact the efficiency of the data transmission. Accordingly, accurate predictions in channel signal strength values are desired.

### SUMMARY

In various embodiments, systems and methods provide the ability to optimize the data transmission rate in a HSDPA system by applying a predictive filter to approximate the future value of Channel Quality Indicator (CQI) for a channel, based upon a stream of stale CQI values for the channel. The approximated future value of CQI is used to schedule the transmission of data over the channel. In an embodiment, a root method may be used by the predictive filter to approximate a future value of CQI. The root method algorithm provides an adaptive filter that is relatively low in complexity and requires relatively low memory resources as compared to other known approaches.

In an alternative embodiment, the predictive filter used to predict a future value of CQI may employ a stochastic gradient method. The stochastic gradient method (also referred to as the gradient method) is similarly low in complexity and requires relatively low memory resources as compared to other approaches. The various embodiment predictive filters may be implemented by either the base station or by mobile device processors to control and modify transmission parameters originating at either device.

### BRIEF DESCRIPTION OF THE DRAWINGS

The accompanying drawings, which are incorporated herein and constitute part of this specification, illustrate embodiments of the invention, and, together with the general description given above and the detailed description given below, serve to explain features of the invention.

FIG. 1 is a system component diagram of a 3G Mobile Telephone communication system illustrating various mobile devices in communication with a base station.

FIG. 2 is a process flow diagram of an embodiment method that may be implemented on a transmitting device in a HSDPA communication system.

FIG. 3 is a component block diagram of a exemplary mobile device that may implement the embodiment predictive filters.

FIG. 4 is a component block diagram of an exemplary base station processing device that may implement the embodiment predictive filters.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term user equipment (UE), user station, mobile station or mobile device may refer to any one or all of cellular telephones, personal data assistants (PDA's), palm-top computers, laptop computers, wireless electronic mail receivers (e.g., the Blackberry® and Treo® devices), multimedia Internet enabled cellular telephones (e.g., the Blackberry Storm®), and similar personal electronic devices that include a programmable processor and memory. In a preferred embodiment, the mobile device is a cellular handset capable of high speed data communication over a cellular telephone network (e.g., a cellphone).

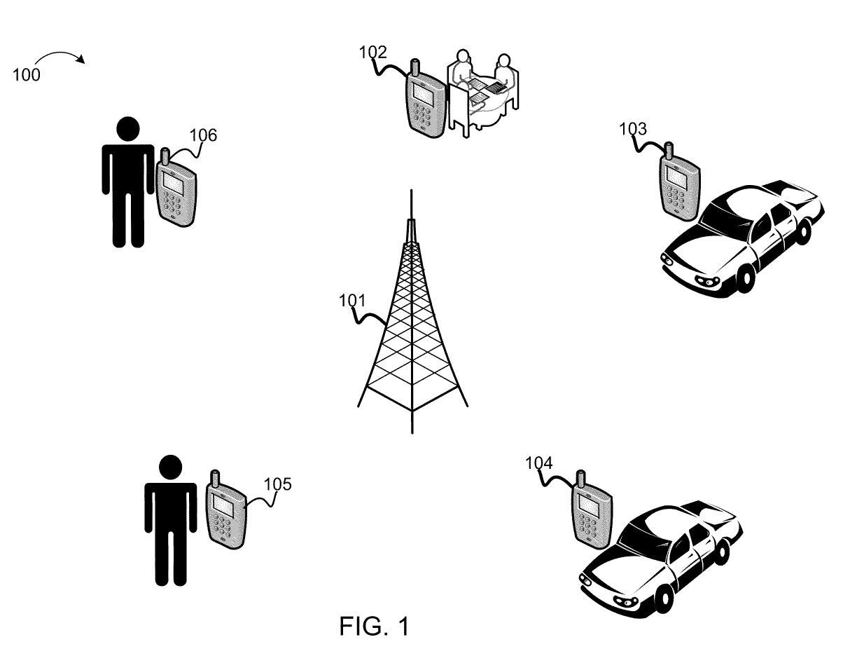

FIG. 1 is a system component diagram of a communication cell operating within a wireless telecommunications system that may employ the various embodiments disclosed herein. In FIG. 1 a base station 101 services a cell 100 operating within a wireless telecommunications system. At any particular moment, any of a number of mobile devices 102-106 may be within range of base station 101 and relying on base station 101 to send and receive data transmissions and support their respective voice and data communications.

Each of the mobile devices 102-106 may be operating under different conditions that can affect the quality of the communication channel each mobile device establishes with the base station 101. For example, stationary users may use their mobile devices 102 and establish a communication link over a channel with the base station 101. Other users may be mobile on foot as illustrated by the users of mobile devices 105 and 106. A typical speed of users walking while employing their mobile device 105, 106 is around 3-5 kmh. Other users may use their mobile devices while driving/riding in a car, as illustrated by mobile devices 103 and 104. Typically, mobile devices used in cars move at speeds between 0 and 120 kmh.

The Universal Mobile Telecommunications System (UMTS) is one of the technologies standardized by the International Telecommunications Union Telecommunication Standardization Sector (ITU-T) for third generation (3G) networks. High-Speed Downlink Packet Access (HSDPA) was included by the 3rd Generation Partnership Project (3GPP) Release 5/6 to improve both the capacity and end-to-end performance of Wideband Code Division Multiple Access (WCDMA) systems, where a mobile device under optimal conditions can receive data at a rate up to 14 Mbps. As part of HSDPA, each mobile device must periodically report a Channel Quality Indicator (CQI), indicating the downlink channel condition to Node B (base station). The CQI is transmitted using a specific physical uplink channel, namely the High-Speed Dedicated Physical Control Channel (HS-DPCCH). The accuracy of the CQI is crucial for the system performance. However, in the current HSDPA specification, the CQI used by Node B in each subframe is presumed to be three (3) subframes stale.

Based upon the various CQIs that are reported back to the base station, the base station may determine how to schedule the transmission of data to each respective mobile device. For example, if a mobile device reports exceptionally high CQI values, indicating a strong signal channel link between the base station and the mobile device, the base station may elect to transmit data to the mobile device in large packet sizes, with minimal error correction and interleaving to achieve a high data rate. Thus, data throughput to mobile devices reporting high CQI values may be high. In contrast, if a mobile device reports an exceptionally low CQI value, indicating a weak signal channel link between the base station and the mobile device, the base station may elect to transmit data to the mobile device in small packet sizes using maximal error correction coding and interleaving schemes which will compensate for the weak link but result in a low data rate. Thus, data throughput to the mobile device may be low.

Channel quality may be influenced by a variety of factors. For example, the relative position of the mobile device to the base station affects CQI, because as mobile devices move away from the base station, signal strength declines and the CQI value tend to decrease. Geographic and atmospheric conditions in a particular location may also influence the CQI. For example, geographic features such as mountains, buildings, trees, etc. may cause interference between the mobile device and the base station. Such interference may degrade the signal strength of the communication channel between the mobile device and the base station, thus lowering the CQI.

Channel quality also varies over time for moving mobile devices. While the CQI for stationary users will rarely change during the course of voice or data communication session with the base station 101, the CQI will change during the course of a voice or data communication for moving users. Indeed, while the change in CQI for the mobile devices being used by walking users (e.g., mobile device 105 and 106) may be slight, the CQI may change rapidly for fast moving users, such as users in cars (e.g., mobile device 103 and 104). As a result, significant fading performance problems may exist for mobile users. The changing channel quality, and thus changing CQI values, may cause inefficiencies in data throughput in an HSDPA system.

In HSDPA systems, a base station schedules the transmission of data packets in accordance with the received CQI values. This scheduling process may modify packet size, error correction, interleaving, and other parameters affecting the data rate. Typically, there is a delay of 6-7 ms from when a base station modifies the various transmission parameters until the actual transmission of the data. As a result of this scheduling delay, by the time data is actually transmitted significant changes in the channel quality may have occurred which may degrade the transmission efficiency of the system. For example, data initially scheduled for transmission over a channel reporting a high CQI may now have a low channel quality, and as a result the data may be transmitted in a format unsuitable for the actual conditions and as a consequence data may not be accurately received. In contrast, data initially scheduled for transmission over a channel reporting a low CQI may now have much better channel quality. As a result, the system is unable to capitalize on the opportunity to send data using a higher data rate.

In addition, some advanced receivers employ offline processing for enhanced demodulation performance. For example, in some modem devices the data processing is performed offline and thus, may add to the delay in actually transmitting the data. As a result, the measured CQI value is stale by the time the CQI report is transmitted back to the base station 101. In some instances, less data is sent than could be accurately sent over the communication channel. In other instances, too much data is sent over a degraded communication channel, resulting in error laden data packets that cannot be accurately decoded. In both cases, the optimal data throughput is not achieved.

Conventional finite impulse response (FIR) filter based predictors implementing the Least-Mean-Squares (LMS) and Recursive-Least-Squares (RLS) approaches, which are adaptive versions of the linear minimum mean-squared error (LMMSE) predictor. These approaches are well known and understood. However, such predictive filters are overwhelmingly complex and impractical to implement. It is desirable to develop a low complexity and low memory requirement CQI-prediction algorithm that could improve the system throughput.

The various embodiments implement adaptive filters that provide adaptive causal predictions of CQI. The embodiment adaptive filters take into account recent historical CQI values to predict future CQI values. The adaptive filters are a linear combination of the most recent CQI value and the existing filter states. While the convergence properties of adaptive infinite impulse response (IIR) filters are largely unsolved, they can provide significantly better performance than their FIR counterparts having the same number of coefficients, indicating a smaller implementation complexity.

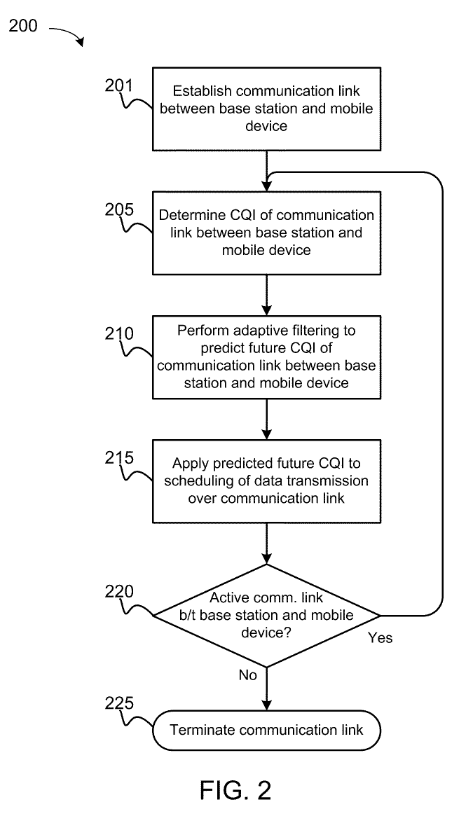

FIG. 2 is a process flow diagram illustrating a method 200 that may be implemented by the processor of a transmitting device (e.g., mobile device or base station) using any of the various embodiments disclosed herein. The method 200 begins when the mobile device 102-106 and base station 101 establish a communication link with one another, step 201. During the period of time that a communication link is established between the base station 101 and a mobile device 102-106, the CQI of the communication link is periodically determined, step 205. In some instances, the periodicity may be of such short duration that the CQI of the communication link may be said to be continuously determined. In instances where the transmission device is the base station 101, it may be more efficient for each mobile device linked to the base station to determine the CQI of the communication link and transmit the CQI value to the base station 101 via a specific physical uplink channel, such as the HS-DPCCH. As the CQI is periodically obtained (i.e., received or determined), a historical record or sequence of CQI values for the communication link may be stored. Using the historical record of CQI values, any of the various embodiment adaptive filter calculations may be implemented to predict an approximation of a future CQI value of the communication link between the base station 101 and the mobile device (e.g., 102-106), step 210. The various embodiment adaptive filters are discussed in more detail below. Once the predicted approximation of the future QCI value has been calculated by an embodiment adaptive filter calculation, the predicted CQI value is applied to the scheduling of the data transmission over the communication link, step 215. The scheduling of the data transmission may include the size of data packets, the amount of error correction coding, or the amount of interleaving.

After the scheduling and transmission of data packets is complete for a given CQI prediction, the processor of the transmitting device may determine if the communication link between the mobile device and base station 101 is still active, determination 220. For example, the mobile device may have moved out of the effective range of base station 101 and a handoff may have occurred, such that the mobile device is now being supported by a different base station. Alternatively, the mobile device may have completed its desired communication session and powered off. In any case, if the communication link is still active (i.e., determination 220=Yes), the processor may return to step 205 to obtain the CQI of the communication link between the base station and the mobile device. If the communication link is no longer active (i.e., determination 220=No), the transmitting device may terminate the communication link. For example, in instances where the transmitting device is the base station 101, if the mobile device has already powered off or been handed off to another base station, the base station may take appropriate steps to terminate the communication link so that the channel may be used by another mobile device, step 225.

The various embodiments implement a special first order adaptive IIR filter calculation to predict CQI in HSDPA. While previous applications of adaptive IIR filters have been mainly directed toward system identification, adaptive IIR filtering has rarely been applied to parameter tracking and prediction. While the adaptive IIR filtering convergence proofs may be borrowed from their system identification applications, the convergence rate is still undetermined. In addition, the convergence proofs supplied from the system identification application still fail to provide insight as to how to choose the parameters in the algorithm.

In various embodiments, the steady state mean squared error (MSE) is derived as a function of the single parameter alpha (α). By minimizing the MSE, an exact gradient descent algorithm may be derived as well as two pseudolinear regression algorithms. Under the assumption that the parameter α evolves slowly, the proposed algorithms are shown to converge using contraction mapping. However, the pseudolinear regression algorithms do not converge to the same optimal equilibrium point as does the exact gradient descent algorithm. The various embodiments specify the conditions under which the convergent point of the pseudolinear regression algorithms is close to that of the exact gradient descent algorithm. Further, the various embodiments consider the relationship between MSE minimization and mutual information maximization. It has been determined that the former can be considered to be an approximation of the latter. In case of LMMSE and Gaussian stochastic processes, the two problems are equivalent. This finding leads to a new relationship between mutual information and MSE, which generalizes the result in D. Guo, S. Shamai, and S. Verdu, “Mutual information and minimum mean-square error in Gaussian channels,” IEEE Trans. Inform. Theory, vol. 51, no. 4, pp. 1261-82, April 2005. The entire contents of which are hereby incorporated by reference. Simulations using the various embodiments indicate a smaller MSE than a 32-tap LMS or RLS which leads up to 25% HSDPA throughput improvement

Rather than restricting the CQI prediction in HSDPA, a general prediction problem is considered. Specifically, for a stochastic process {μ(n)}, the prediction of the function value K-step ahead is desired, i.e., μ(n+K), given the past symbols μ(l), . . . , μ(n). With μ(n) representing the CQI in the n-th subframe in HSDPA (i.e., sequence of CQI values), the process {μ(n)} is wide-sense stationary for algorithm derivation purpose. The algorithm and analysis are concerned with real variables (μ(n) ε R) as CQI is a real number. The proposed algorithm can be readily extended to the case in which the process is complex. It may be assumed that the process to be predicted is the same as the observed process, not only for notational simplicity but also for the application of CQI. The obtained results can be readily extended to the case when the two processes are different.

In order to compare the embodiment algorithms, a brief review of a LMMSE predictor may be made for comparison with the embodiment algorithms. With a LMMSE predictor, μ(n+K) is predicted using

\hat{μ}(n+K)=w^{T}(n)μ(n) (1)

where w(n)=[ω₁(n), . . . , ω_{M}(n)]^{T}, μ(n)=[μ(n), . . . , μ(n . . . M+1)]^{T}, and M is the number of observations used for prediction or the number of taps of the FIR filter. w(n) is chosen to minimize E{|μ(n+KE={|μ(n+K)−\hat{μ}(n+K)|²}, whose solution

$$\begin{matrix}w ( n ) = {R}^{- 1} ( n ) d ( n ) , \\ where d ( n ) = {[ ϕ ( K ) , … ϕ ( K + M - 1 ) ]}^{T} and & ( 2 ) \\ R ( n ) = e \{ u ( n ) {u}^{T} ( n ) \} = [ \begin{matrix}ϕ ( 0 ) & ϕ ( 1 ) & … & ϕ ( M - 1 ) \\ ϕ ( 1 ) & ϕ ( 0 ) & & ϕ ( M - 2 ) \\ & ⋮ & ⋱ & ⋮ \\ ϕ ( M - 1 ) & ϕ ( M - 2 ) & … & ϕ ( 0 )\end{matrix} ] & ( 3 )\end{matrix}$$

and φ(i)=E{μ(n)μ(n+i)} is the autocorrelation function. Note that equation (1) is a causal LMMSE predictor. When n→+∞, the equation becomes a causal Wiener-Kolmogorov filter. LMS and RLS can be considered to be adaptive versions of the LMMSE predictor. When n→+∞, and M=n, the closed-form of MSE can be obtained as disclosed in R. A. Horn and C. R. Johnson, Matrix Analysis, Cambridge University Press, 1990. The entire contents of which are hereby incorporated by reference.

$$\begin{matrix}{σ}_{LMMSE}^{2} = \{ \begin{matrix}{e}^{{C}_{0}} , & K = 1 , \\ ( 1 + {\vert {c}_{1} \vert}^{2} ) {e}^{{C}_{0}} , & K = 2 , \\ ( 1 + {\vert {c}_{1} \vert}^{2} + {\vert {c}_{2} + \frac{1}{2} {c}_{1}^{2} \vert}^{2} ) {e}^{{C}_{0}} , & K = 3 , \\ ( 1 + {\vert {c}_{1} \vert}^{2} + {\vert {c}_{2} + \frac{1}{2} {c}_{1}^{2} \vert}^{2} + {\vert {c}_{3} + {c}_{1} c + 2 \frac{1}{6} {c}_{1}^{3} \vert}^{2} ) {e}^{{c}_{0}} , & K = 4 ,\end{matrix} \\ where & ( 4 ) \\ {c}_{n} = \frac{1}{2 π} {\int }_{- π}^{π} {e}^{jω n} log Φ ( ω ) d ω , n ∈ Z , & ( 5 )\end{matrix}$$

and Φ(ω) demnotes the power spectral density of {μ(n)}, i.e.,

$$Φ ( ω ) = {\sum }_{n = - ∞}^{∞} ϕ ( n ) {e}^{- jω n} .$$

Note that when LMS and RLS are used, due to the stochastic nature of both algorithms, they typically oscillate around the optimal weight vector, even though their averages converge to the optimum. Therefore, there is an excess MSE in both LMS and RLS, determined by the stepsize in the algorithm.

To get good prediction accuracy, LMS or RLS typically requires a large M, as well as a complicated vector operation. To overcome these problems, the various embodiments implement first order adaptive IIR predictors. It may be assumed that the first order adaptive IIR predictor takes the form:

\hat{μ}(n+K)=(1−α(n))\hat{μ}(n)+α(n)μ(n), (6)

where α(n) is an IIR filter coefficient at time n. Note that equation (6) is a first order adaptive IIR filter. The form shown in equation (6) is chosen as opposed to β(n)\hat{μ}(n)+α(n)μ(n), in order to keep E{\hat{μ}(n+K)}=E{μ(n+K))} at the steady state, which means that the estimate is unbiased. Also, adjusting one parameter α(n) has a lower complexity than adapting two parameters. The problem is then to solve as:

min_{α(n)}E{|(1−α(n))\hat{μ}(n)+α(n)μ(n)−μ(n+K)|²}. (7)

This result provide a first order adaptive IIR predictor.

Assuming that {μ(n)} and {\hat{μ}(n)} are jointly wide-sense stationary, i.e, E{\hat{μ}(n+k)μ(n)}=E{\hat{μ}(k)μ(0)} for all k, n, which implies that the sequence α(n) has converged to α. The objective function in equation (7) may be expanded as

$$\begin{matrix}\begin{matrix}{σ}_{IIR}^{2} = E \{ {\vert \hat{u} ( n + K ) - u ( N + K ) \vert}^{2} \\ = E \{ {\vert \hat{u} ( n + K ) \vert}^{2} \} + E \{ {\vert u ( n + K ) \vert}^{2} \} - \\ 2 E \{ \hat{u} ( u + K ) u ( n + K ) \} \\ = \hat{p} ( 0 ) + p ( 0 ) - 2 q ( 0 ) ,\end{matrix} & ( 8 ) \\ \begin{matrix}where \hat{p} ( k ) = E \{ \hat{u} ( n ) \hat{u} ( n + k ) \} , \\ p ( k ) = E \{ u ( n ) u ( n + k ) \} , \\ and q ( k ) = E \{ \hat{u} ( n ) u ( n + k ) \} .\end{matrix} & \end{matrix}$$

From equation (6) it is determined that

$$\begin{matrix}\hat{p} ( 0 ) = E \{ {\vert \hat{u} ( n + K ) \vert}^{2} \} \\ = {( 1 - α )}^{2} E \{ {\vert \hat{u} ( n ) \vert}^{2} \} + {α}^{2} E \{ {\vert u ( n ) \vert}^{2} \} + 2 α ( 1 - α ) E \{ \hat{u} ( n ) u ( n ) \} \\ = {( 1 - α )}^{2} \hat{p} ( 0 ) + {α}^{2} p ( 0 ) + 2 α ( 1 - α ) q ( 0 ) \\ ∴ \hat{p} ( 0 ) = \frac{α}{2 - α} p ( 0 ) + \frac{2 ( 1 - α )}{2 - α} q ( 0 ) .\end{matrix} \qquad ( 9 )$$

Substituting \hat{p}(0) in equation (9) into equation (8), it may be determined that

$${σ}_{IIR}^{2} = \frac{2}{2 - α} ( p ( 0 ) - q ( 0 ) . \qquad ( 10 )$$

Thus, only q(0) is needed to be derived. From the definition of q(0) it is determined that

$$\begin{matrix}q ( 0 ) = E \{ \hat{u} ( n ) u ( n ) \} \\ = ( 1 - α ) E \{ \hat{u} ( n - K ) u ( n ) \} + α E \{ u ( n - K ) u ( n ) \} \\ = ( 1 - α ) q ( K ) + αp ( K ) .\end{matrix} \qquad ( 11 )$$

Applying equation (11) recursively, it is determined that

$$q ( 0 ) = α {\sum }_{i = 1}^{∞} {( 1 - α )}^{i - 1} p ( i K ) . \qquad ( 12 )$$

Finally, the MSE of adaptive IIR predictor is

$${σ}_{IIR}^{2} ( α ) = \frac{2}{2 - α} ( ϕ ( 0 ) - α {\sum }_{i = 1}^{∞} {( 1 - α )}^{i - 1} ϕ ( i K ) ) , \qquad ( 13 )$$

where φ(i)=E{μ(n)μ(n+i)} is the autocorrelation function. By using Φ(ω), the power spectrum of φ(n), equation (13) may be rewritten as

$${σ}_{IIR}^{2} = \frac{2}{2 - α} \frac{1}{2 π} {\sum }_{- π}^{π} Φ ( ω ) \frac{1 - {e}^{j K ω}}{1 - ( 1 - α ) {e}^{j K ω}} d ω , \qquad ( 14 )$$

when 0<α<2. This result can be used as a steady state MSE of a first order adaptive IIR predictor.

By taking the derivative of σ_{IIR}² (α)with respect to α, equation (15) may be obtained.

$$\frac{d {σ}_{IIR}^{2} ( α )}{d α} = \frac{α p ( 0 ) - 2 q ( 0 ) + α ( 2 - α ) {\sum }_{i = 1}^{∞} {( 1 - α )}^{i - 1} q ( i K )}{{α ( 2 - α )}^{2}} \qquad ( 15 )$$

By using the stochastic gradient method as LMS, q(iK) may be replaced by \hat{μ}(n−iK)μ(n) and p(0) by μ²(n). Thus, the gradient descent method updates α(n) using

α(n+1)=[α(n)−μ(α(n)μ²(n)−2\hat{μ}(n)μ(n)+α(n)(2−α(n))μ(n)ζ(n)))]₀², ζ(n)=\hat{μ}(n−K)+(1−α(n))ζ(n−K). (16)

where μ>0 is a stepsize. This equation may be used as a gradient based algorithm.

In an embodiment, the predictive filter to approximate a future value of CQI may employ a pseudo-linear regression algorithm which is referred to herein as the root method. The root method algorithm provides an adaptive filter that is relatively low in complexity, and that requires relatively low memory resources as compared to other known method using the LMS or RLS approach.

Expanding the objective function of equation (7) above, the following equation (17) may be obtained.

$$\begin{matrix}f ( α ( n ) ) = E \{ {\vert ( 1 - α ( n ) ) \hat{u} ( n ) + α ( n ) u ( n ) - u ( n + K ) \vert}^{2} \} \\ = {( 1 - α ( n ) )}^{2} E \{ {\vert \hat{u} ( n ) \vert}^{2} \} + {α}^{2} ( n ) E \{ {\vert u ( n ) \vert}^{2} \} + \\ E \{ {\vert u ( n - K ) \vert}^{2} \} + 2 α ( n ) ( 1 - α ( n ) ) E \{ \hat{u} ( n ) u ( n ) \} - \\ 2 ( 1 - α ( n ) ) E \{ \hat{u} ( n ) u ( n + K ) \} - 2 α ( n ) E \{ u ( n ) u ( n + K ) \} \\ = {( 1 - α ( n ) )}^{2} \hat{p} ( 0 ) + ( 1 + {α}^{2} ( n ) ) p ( 0 ) + \\ 2 α ( n ) ( 1 - α ( n ) ) q ( 0 ) - 2 ( 1 - α ( n ) ) q ( K ) - \\ 2 α ( n ) p ( K )\end{matrix} \qquad ( 17 )$$

Note that due to the recursive structure of equation (6), α(n) is a function of all α(i), μ(i), i=1, . . . , n−1. In other words, α(i), μ(i) are also implicit functions of α(n). Minimizing equation (17) over α(n) should also take into account this dependence.

If we ignore such a dependence, i.e., α(n) does not depend on α(i), μ(i), i=1, . . . , n−1, minimizing equation (17) over α(n) gives

$${α}^{*} ( n ) = \frac{p ( K ) + \hat{p} ( 0 ) - q ( 0 ) - q ( K )}{\hat{p} ( 0 ) + p ( 0 ) - 2 q ( 0 )} \qquad ( 18 )$$

In equation (18), the terms \hat{p}(k), p(k) and q(k) may be replaced with their time averages. For example,

$$\begin{matrix}\hat{p} ( k , n ) = \frac{1}{n - k} {\sum }_{i = 1}^{n - k} \hat{u} ( i ) \hat{u} ( i + k ) \\ = \frac{1}{n - k} \hat{u} ( n - k ) \hat{u} ( n ) + \\ \frac{n - k - 1}{n - k} \hat{p} ( k , n - 1 ) \\ p ( k , n ) = \frac{1}{n - k} {\sum }_{i = 1}^{n - k} u ( i ) u ( i + k ) \\ = \frac{1}{n - k} u ( n - k ) u ( n ) + \\ \frac{n - k - 1}{n - k} p ( k , n - 1 ) \\ q ( k , n ) = \frac{1}{n - k} {\sum }_{i = 1}^{n - k} \hat{u} ( i ) u ( i + k ) \\ = \frac{1}{n - k} \hat{u} ( n - k ) u ( n ) + \\ \frac{n - k - 1}{n - k} q ( k , n - 1 )\end{matrix} \qquad collectively equation ( 19 )$$

where \hat{p}(k, 0)=p(k, 0)=q(k, 0). Replacing \hat{p}(k), p(k), and q(k) in equation (18) with \hat{p}(k, n), p(k, n) and q(k, n), α(n) can be computed in each subframe as

$$α ( n ) = \frac{p ( K , n ) + \hat{p} ( 0 , n ) - q ( o , n ) - q ( K , n )}{\hat{p} ( o , n ) + p ( o , n ) - 2 q ( 0 , n )}$$

This algorithm is referred to as the root method algorithm.

In an alternative embodiment, the predictive filter to approximate a future value of CQI may employ a stochastic gradient method. The stochastic gradient method (also referred herein as the gradient method) is similarly low in complexity and requires relatively low memory resources as compared to other known method using the LMS or RLS approach.

The derivative of equation (17) above with respect to α(n) may be obtained as

$$\frac{d f ( α ( n ) )}{d α ( n )} = ( 2 \hat{p} ( 0 ) - 4 q ( 0 ) + 2 p ( 0 ) ) α ( n ) + 2 q ( K ) - 2 p ( K ) - 2 \hat{p} ( 0 ) + 2 q ( 0 ) \qquad ( 20 )$$

where the dependence of q(K) on α(n) may be ignored. Applying the stochastic gradient method of the alternative embodiment, \hat{p}(k), p(k), and q(k) may be replaced with \hat{μ}(n)\hat{μ}(n−k), μ(n−k)and \hat{μ}(n−k)μ(n), respectively. Thus, the stochastic gradient algorithm for updating α(n) becomes:

α(n+1)=[α(n)−2μ((\hat{μ}(n)−μ(n))(\hat{μ}(n−K)−μ(n−K)))]₀¹ (21)

where [·]₀¹ denotes mapping to the interval [0,1] and μ is a stepsize for α(n) update. In addition, the stochastic gradient algorithm may be derived by differentiating equation (7) directly with respect to α(n), which gives the gradient \hat{μ} (n+K)−μ(n+K)(\hat{μ}(n)−μ(n)). However, at time n when updating α(n), we do not know μ(n+K). Therefore, the time in the gradient may be shifted K, and then α(n) may be updated using

α(n+1)=[α(n)−2μ((\hat{μ}(n)−μ(n))(\hat{μ}n−K)−μ(n−K)))]₀² (22)

As discussed below, the two gradient equations (21) and (22) for updating α(n) have the same convergence conditions even though their dynamics may be different.

When there is noise in μ(n), i.e., μ(n)=h(n)+ν(n), ν(n) is additive White Gaussian noise (AWGN) with zero mean and variance σ_{ν}², interest lies only in h(n+K) rather than μ(n+K). In such instances, E{μ²(n)} may be replaced with E{h²(n)} in equation (17). Assuming that variance σ_{ν}² is known, e.g., it could possibly be estimated via the common pilot channel (CPICH) in HSDPA, it may be determined that E{μ²(n)}=E{h²(n)}+σ_{ν}² . Therefore, in order to minimize E{|\hat{μ}(n)−h(n)|²} equation (21) may become

α(n+1)=[α(n)−2μ(((|\hat{μ}(n)|²−2\hat{μ}(n)μ(n)+|μ(n)|²σ_{ν}²)α(n)+\hat{μ}(n−K)μ(n)−μ(n)μ(n−K)−|\hat{μ}(n)|²+\hat{μ}(n)μ(n))]₀²

Experimental simulations have revealed that the system's dynamic is sensitive to μ. In some embodiments μ may be chosen according to the average level of the absolute value of the gradient. Alternatively, μ may be chosen according to the average gradient square:

d(n)=2((\hat{μ}(n)−μ(n))\hat{μ}(n+K)−(\hat{μ}(n−K)−μ(n−K))μ(n)). (23)

Let d̅(n) be the average value of |d(n)| update to time n, i.e.,

$$\overline{d} ( n ) = \frac{1}{n} {\sum }_{i = 1}^{n} \vert d ( n ) \vert = \frac{1}{n} \vert d ( n ) \vert + \frac{n - 1}{n} {d}^{…} ( n - 1 ) , \qquad ( 24 )$$

then μ may be chosen to satisfy the equation

$$μ = \frac{{μ}^{′}}{\overline{d} ( n )} ,$$

where μ′>0 is a constant. In order to speed up the convergence, a fast start algorithm may be used. For example, μ′=0.02 if n<Nₜₕ and μ′=0.005 otherwise, where Nₜₕ is the end threshold for the fast start period. To reduce system complexity, μ does not need to be updated every subframe, rather only once in ω subframes, where ω>0 is the interval between two μ updates.

By expanding (6), an n-tap minimum mean-squared error (MMSE) filter may be obtained for time n. The IIR predictor can be considered to be a variable length MMSE filter even though it appears to only contain one tap and there is a single parameter to control the MSE. This may possibly explain why an adaptive IIR predictor is better than a finite impulse response predictor given the same number of coefficients.

Thus, it is determined that performing a High Speed CQI Prediction Filter (HS-CPF) using the root method embodiment only requires nine (9) additions, seven (7) multiplication functions, and memory for seven (7) variables. Similarly, performing the HSCPF using the gradient method only requires seven (7) additions, seven (7) multiplication functions, and memory for three (3) variables. In contrast, performing such HSCPF using either the LMS or RMS method typically require much more complexity and memory to achieve the same performance.

In general, it is hard to optimize equation (13) and compute the minimum MSE in closed-form for arbitrary φ(i). In the following, the example where K=1 is considered to illustrate the steady state MSE of the adaptive IIR filter.

Let μ(n)=h(n)+ν(n), where ν(n) is Gaussian with zero mean and variance σ_{ν}² and E{(h(i)h(i+n))}=φ(ω_{d}n). The autocorrelation function φ(n) has the spectrum

$$S ( ω ) = \{ \begin{matrix}\frac{π}{{ω}_{d}} & if \vert ω \vert \leq {ω}_{d} \\ 0 & otherwise\end{matrix} \qquad ( 25 )$$

as an approximation to the Jakes' model, ω_{d}=2πTₛƒ_{d}, where Tₛ is the sampling rate and ƒ_{d} is the Doppler frequency. From equation (4) the MSE of LMMSE is

$$\begin{matrix}{σ}_{LMMSE}^{2} = exp \{ \frac{1}{2 π} ( {\int }_{- {ω}_{d}}^{{ω}_{d}} log ( {σ}_{v}^{2} + \frac{π}{{ω}_{d}} ) + 2 {\int }_{{ω}_{d}}^{π} log {σ}_{v}^{2} ) d ω \} \\ = {( {σ}_{v}^{2} + \frac{π}{{ω}_{d}} )}^{\frac{{ω}_{d}}{π}} {( {σ}_{v}^{2} )}^{\frac{π - {ω}_{d}}{π}} .\end{matrix} \qquad ( 26 )$$

For an adaptive IIR predictor, one can derive

$$\begin{matrix}{\sum }_{i = 1}^{∞} {( 1 - α )}^{i - 1} ϕ ( i K ) = {\sum }_{i = 0}^{∞} {( 1 - α )}^{i} \frac{1}{2 {ω}_{d}} {\int }_{- {ω}_{d}}^{{ω}_{d}} {e}^{j ( i + 1 ) K ω} d ω \\ = \frac{1}{{K}_{{ω}_{d}} ( 1 - α )} arctan ( \frac{( 2 - α )}{α} tan \frac{K {ω}_{d}}{2} ) - \\ \frac{1}{2 ( 1 - α )}\end{matrix} \qquad ( 27 )$$

where |1−α|<1. Substituting equation (27) into equation (13), the MSE of adaptive IIR predictor may be obtained as

$${σ}_{IIR}^{2} ( α ) = \frac{2}{2 - α} ( 1 + {σ}_{v}^{2} \frac{α}{K {ω}_{d} ( 1 - α )} arctan ( \frac{2 - α}{α} tan \frac{K {ω}_{d}}{2} ) ) + \frac{2 α}{2 ( 1 - α ) ( 2 - α )} . \qquad ( 28 )$$

It may be difficult to obtain a closed form solution of α by minimizing σ_{IIR}²(α) in equation (25). Thus, equation (28) may be minimized numerically and the MSE of IIR may be compared using the exact gradient method, denoted as “IIR Optimal” with that of LMMSE in equation (26). The achieved MSE may be included by using a pseudolinear regression method, denoted as “IIR PseudoLinear”. Assuming that

$${ω}_{d} = \frac{2 π {f}_{C} {T}_{S} v}{c} ,$$

where ƒ_{c}=1.9 GHz is the carrier frequency, c is the speed of light in km/h, ν is the speed that the mobile device is moving at in km/h and Tₛ=2 ms is the subframe duration in WCDMA.

When the process {μ(n)} is non-stationary, the pseudolinear regression root method may respond slowly to the time variations of the processes because the new contribution to the correlation coefficient in equation (19) decays as 1/n, while the gradient method may oscillate too much. To track the time variation, \hat{p}(k), p(k), and q(k) may be estimated using a finite sliding window rather than an infinite window. Alternatively, another IIR filter may be used to update \hat{p}(k), p(k), and q(k) , where the coefficient of this IIR filter could either be fixed to a constant value or be adjusted adaptively. The root method can also be combined with the gradient method by running the gradient method first using a large stepsize and then applying the root method to take advantage of the fast start of the gradient method and the smooth dynamic of the root method.

To smooth the dynamic of the gradient method, the gradient in equation (20) may be estimated using a short window, which includes equation (21) as a special case using a window of size 1. α(n) may also be updated using a window of size W, i.e., equation (21) is replaced by

$$α = {[ \overline{α} ( n ) - 2 μ ( \begin{matrix}( \hat{u} ( n ) - u ( n ) ) \hat{u} ( n + K ) - \\ ( \hat{u} ( n - K ) - u ( n - K ) ) u ( n )\end{matrix} ) ]}_{0}^{2} \\ \overline{α} ( n + 1 ) = \frac{1}{w} {\sum }_{i = n - w + 2}^{n + 1} α ( i ) . \qquad ( 29 )$$

Minimizing the MSE has been considered in a single subframe. In addition, minimizing a general cost function may be considered, for example, the weighted least squares error function

$$C ( {w}_{n} ) = {\sum }_{i = 0}^{n} {λ}^{n - 1} {\vert u ( i ) - \hat{u} ( i ) \vert}^{2} \qquad ( 30 )$$

where 0<λ≦1 is an exponential weighting factor or forget factor, effectively limiting the number of input samples based on which cost function is minimized or the memory of the algorithm. All proposed algorithms can be readily generalized to this case.

The convergence analysis of adaptive IIR filters is somewhat limited and the problem is still largely unsolved. Due to the simplicity of the proposed adaptive IIR filter the convergence of the various embodiments may be shown using contraction mapping. From equation (21), it may be shown that the fixed point of equation (21), α*, satisfies the equation

$${\int }_{- π}^{π} Φ ( ω ) ( \frac{{α}^{*}}{2 - {α}^{*}} - {e}^{j K ω} ) \frac{1 - {e}^{j K ω}}{1 - ( 1 - {α}^{*} ) {e}^{j K ω}} d ω = 0 , \\ {α}^{*} ∈ ( 0 , 2 ) . \qquad ( 31 )$$

Thus, the following theorem is postulated. Theorem: If the initial α(0) is within a small neighbor of α*, i.e., |α(0)−α*|<δ, and 2φ(0)−3φ(1)+2φ(2)−φ(3)>0, E{α(n)}, using the pseudolinear gradient method of equation (21) converges to α* exponentially with a sufficiently small stepsize.

Similar results can be obtained for the pseudolinear root method of equation (18). This theorem may be proven in equation (8) by using the contraction mapping theorem to show that

|E{α(n+1)}−E{α(n)}|<|E{α(n)}−E{α(n−1)}| (32)

It may also be seen that when Φ(ω)≧0, 2φ(0)−3φ(1)+2φ(2)−φ(3)>0, Jake's model and equation (25) meet this condition. Even though this theorem restricts the initial α(0) to be close to α*, experimental simulations indicate that by choosing α(0)=1, convergence may be ensured.

The embodiment algorithms may be implemented in a variety of devices. For example, in a typical HSDPA system the mobile device 102-106 determines the quality of the communication channel in the form of CQI between the mobile device and the base station 101 and reports the CQI back to the base station 101 over a physical uplink channel. In order to leverage the processing power or each individual mobile device, the embodiment CQI prediction calculations may be performed by the individual mobile devices 102-106. Once calculated, each mobile device 102-106 may transmit the calculated predicted CQI value back to the base station 101 in place of the conventional CQI value. The calculated predicted CQI values may be received by the base station 101 and used to schedule the transmission of data to each of the respective mobile devices 102-106.

Alternatively, the base station 101 may continue to receive conventional CQI values from each of the mobile device 102-106 that have established a communication link with the base station 101. Upon receipt of each CQI value the base station may implement any of the embodiment CQI prediction algorithms to calculate the predicted CQI values. The calculated predicted CQI values may be used to schedule the transmission of data to each of the respective mobile devices 102-106. By calculating the predicted value of CQI in the bases station 101, the increased processing power and performance of the computer operating at the bases station 101 may be leveraged. In addition, by performing the calculations at the base station 101, both processing power and battery power of each individual mobile device 102-106 may be conserved.

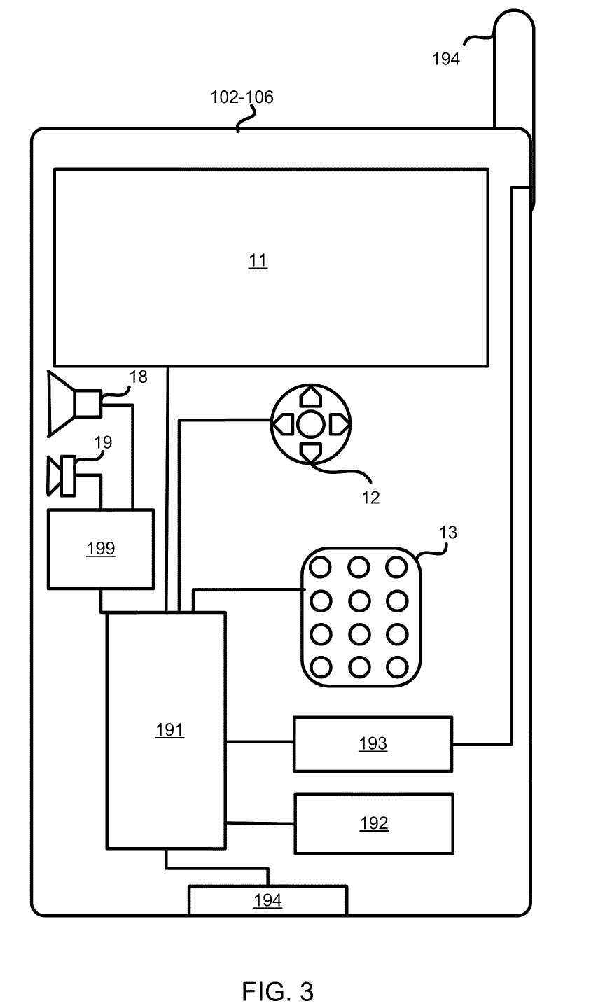

The embodiments described above may be implemented on any of a variety of portable computing devices, such as any of mobile devices 102-106. Typically, such portable computing devices 102-106 will have in common the components illustrated in FIG. 3. For example, the portable computing devices may include a processor 191 coupled to internal memory 192. The processor 191 may also be coupled to a display device 11. Additionally, the portable computing device 100 may have an antenna 194 for sending and receiving electromagnetic radiation which is connected to a wireless data link and/or cellular telephone transceiver 193, coupled to the processor 191. Determination of a CQI may be completed by the processor 191, or in a module of the transceiver 193. Portable computing devices 102-106 typically include some form of input device such as a key pad 13, or miniature keyboard and menu selection keys or rocker switches 12 which serve as pointing devices. Alternatively, some portable computing devices may employ touchscreen technology, wherein virtual keypads may be employed on the display surface 11. The processor 191 may further be connected to a wired network interface 194, such as a universal serial bus (USB) or FireWire® connector socket, in order to connect the processor 191 to an external device or external local area network. The processor 191 may also be coupled to a speaker 18 and microphone 19 through a vocoder 199.

The processor 191 may be any programmable microprocessor, microcomputer, or multiple processor chip or chips that can be configured by software instructions (applications) to perform a variety of functions, including the functions of the various embodiments described above. In some portable computing devices, multiple processors 191 may be provided, such as where one processor is dedicated to wireless communication functions and another processor is dedicated to running other applications. The processor may also be included as part of a communication chipset. Typically, software applications may be stored in the internal memory 192 before they are accessed and loaded into the processor 191. In some portable computing devices, the processor 191 may include internal memory sufficient to store the application software instructions. For the purposes of this description, the term memory refers to all memory accessible by the processor 191, including internal memory 192 and memory within the processor 191 itself Application data files are typically stored in the memory 92. In many portable computing devices, the memory 192 may be a volatile or nonvolatile memory, such as flash memory, or a mixture of both.

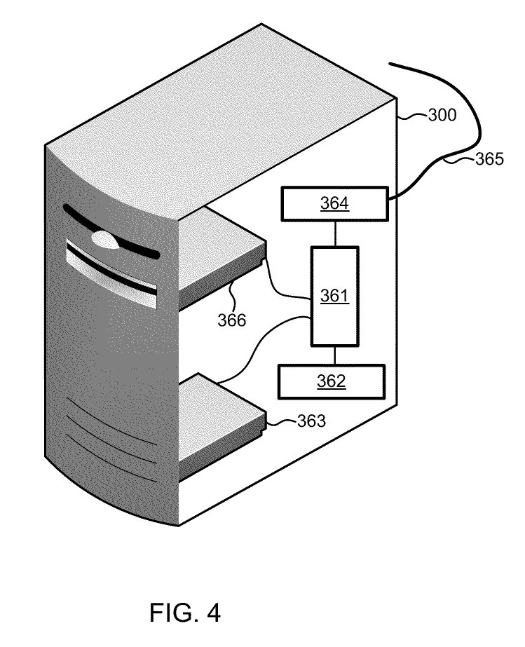

The embodiments described above may be implemented on any of a variety of stationary computing devices, such as at a base station 101. An example of which is the server 300 illustrated in FIG. 4. Such a server 300 typically includes a processor 361, coupled to volatile memory 362, and to a large capacity nonvolatile memory, such as a disk drive 363. The server 300 may also include a floppy disc drive and/or a compact disc (CD) drive 366, coupled to the processor 361. The server 300 may also include a number of connector ports 364, coupled to the processor 361 for establishing data connections with network circuits 365.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for predicting a channel quality indicator (CQI) in a communication channel, comprising:
obtaining a sequence of CQI values for the communication channel on a periodic basis; and
predicting a future CQI value based upon the sequence of CQI values using one of a root method or a gradient method.

2. The method of claim 1, further comprising:
applying the future predicted CQI value to adjust HSDPA scheduling, including determining a packet size and appropriate network resource to a mobile device, wherein obtaining a sequence of CQI values comprises periodically receiving determined CQI values from the mobile device.

3. The method of claim 1, further comprising:
transmitting the predicted future CQI value to a base station, wherein obtaining a sequence of CQI values comprises periodically determining the CQI of the communication channel between the base station and a mobile device.

4. The method of claim 1, wherein predicting comprises
reducing estimation inaccuracy and quantization noise.

5. The method of claim 1, wherein predicting comprises calculating a future CQI value using an adaptive filtering algorithm.

6. The method of claim 5, wherein the adaptive filtering algorithm comprises a one-tap adaptive filtering algorithm.

7. The method of claim 6, wherein the one-tap adaptive filtering algorithm comprises a one-tap minimum mean-squared error (MMSE) adaptive filtering algorithm.

8. The method of claim 7, wherein the one-tap MMSE adaptive filtering comprises a root method.

9. The method of claim 8, wherein the root filtering algorithm comprises minimizing the equation:
E{|(1−α(n))\hat{μ}(n)+α(n)μ(n)−μ(n+K)|²},
with respect to α(n), where
$$α ( n ) = \frac{p ( K , n ) + \hat{p} ( 0 , n ) - q ( o , n ) - q ( K , n )}{\hat{p} ( o , n ) + p ( o , n ) - 2 q ( O , n )} .$$

10. The method of claim 7, wherein the one-tap MMSE adaptive filtering comprises a gradient method.

11. The method of claim 10, wherein the gradient filtering algorithm comprises minimizing the equation:
E{|(1α(n))\hat{μ}(n)+α(n)μ(n)−μ(n+K)|²},
with respect to α(n) , where α(n+1)=[α(n)−2μ((\hat{μ}(n)−μ(n))(\hat{μ}(n−K)−μ(n−K)))]₀¹, and where [.]₀¹ denotes mapping to the interval [0,1] and where μ is a stepsize for α(n) update.

12. A communication device for predicting a channel quality indicator (CQI) in a communication channel, comprising:
means for obtaining a sequence of CQI values for the communication channel on a periodic basis; and
means for predicting a future CQI value based upon the sequence of CQI values using one of a root method or a gradient method.

13. The communication device of claim 12, further comprising:
means for applying the future predicted CQI value to adjust HSDPA scheduling, including means for determining a packet size and appropriate network resource to a mobile device, wherein said means for obtaining a sequence of CQI values comprises a means for periodically receiving determined CQI values from the mobile device.

14. The communication device of claim 12, further comprising:
means for transmitting the predicted future CQI value to a base station, wherein said means for obtaining a sequence of CQI values comprises means for periodically determining the CQI of the communication channel between the base station and a mobile device.

15. The communication device of claim 12, wherein means for predicting comprises means for reducing estimation inaccuracy and quantization noise.

16. The communication device of claim 12, wherein means for predicting comprises means for calculating a future CQI value using an adaptive filtering algorithm.

17. The communication device of claim 16, wherein the adaptive filtering algorithm comprises a one-tap adaptive filtering algorithm.

18. The communication of claim 17, wherein the one-tap adaptive filtering algorithm comprises a one-tap minimum mean-squared error (MMSE) adaptive filtering algorithm.

19. The communication device of claim 18, wherein the one-tap MMSE adaptive filtering comprises a root method.

20. The communication device of claim 19, wherein the root method comprises minimizing the equation:
E{|(1−α(n))\hat{μ}(n)+α(n)μ(n)−μ(n+K)|²}, with respect to α(n), where
$$α ( n ) = \frac{p ( K , n ) + \hat{p} ( 0 , n ) - q ( o , n ) - q ( K , n )}{\hat{p} ( o , n ) + p ( o , n ) - 2 q ( O , n )} .$$

21. The communication device of claim 18, wherein the one-tap MMSE adaptive filtering comprises a gradient method.

22. The communication device of claim 21, wherein the gradient filtering algorithm comprises minimizing the equation:
E{|(1−α(n))\hat{μ}(n)+α(n)μ(n)−μ(n+K)|²},
with respect to α(n) , where α(n+1)=[α(n)−2μ((\hat{μ}(n)−μ(n))(\hat{μ}(n−K)−μ(n−K)))]₀¹, and where [.]₀¹ denotes mapping to the interval [0,1] and where μ is a stepsize for α(n) update.

23. A communication device for predicting a channel quality indicator (CQI) in a communication channel, comprising:
a memory unit; and
a processor coupled to the memory unit, wherein the processor is configured with software instructions to perform steps comprising:
obtaining a sequence of CQI values for the communication channel on a periodic basis; and
predicting a future CQI value based upon the sequence of CQI values using one of a root method or a gradient method.

24. The communication device of claim 23, wherein the processor is configured with software instructions to perform further steps comprising:
applying the future predicted CQI value to adjust HSDPA scheduling, including determining a packet size and appropriate network resource to a mobile device, wherein said obtaining a sequence of CQI values comprises periodically receiving determined CQI values from the mobile device.

25. The communication device of claim 23, wherein the processor is configured with software instructions to perform further steps comprising:
transmitting the predicted future CQI value to a base station, wherein said obtaining a sequence of CQI values comprises periodically determining the CQI of the communication channel between the base station and a mobile device.

26. The communication device of claim 23, wherein the processor is configured with software instructions to perform further steps comprising:
reducing estimation inaccuracy and quantization noise.

27. The communication device of claim 23, wherein the processor is configured with software instructions to perform further steps comprising:
calculating a future CQI value using an adaptive filtering algorithm.

28. The communication device of claim 27, wherein the adaptive filtering algorithm comprises a one-tap adaptive filtering algorithm.

29. The communication of claim 28, wherein the one-tap adaptive filtering algorithm comprises a one-tap minimum mean-squared error (MMSE) adaptive filtering algorithm.

30. The communication device of claim 29, wherein the one-tap MMSE adaptive filtering comprises a root method.

31. The communication device of claim 30, wherein the processor is configured with software instructions to perform further steps comprising minimizing the equation:
E{|(1−α(n))\hat{μ}(n)+α(n)μ(n)−μ(n+K)|²}, with respect to α(n), where
$$α ( n ) = \frac{p ( K , n ) + \hat{p} ( 0 , n ) - q ( o , n ) - q ( K , n )}{\hat{p} ( o , n ) + p ( o , n ) - 2 q ( O , n )} .$$

32. The communication device of claim 29, wherein the one-tap MMSE adaptive filtering comprises a gradient method.

33. The communication device of claim 32, wherein the processor is configured with software instructions to perform further steps comprising minimizing the equation:
E{|(1−α(n))\hat{μ}(n)+α(n)μ(n)−μ(n+K)|²},
with respect to α(n), where α(n+1)=[α(n)−2μ ((\hat{μ}(n)−μ(n))(\hat{μ}(n−K)−μ(n−K)))]₀¹, and where [.]₀¹ denotes mapping to the interval [0,1] and where μ is a stepsize for α(n) update.

34. A tangible storage medium having stored thereon processor-executable software instructions configured to cause a processor to perform steps comprising:
obtaining a sequence of CQI values for the communication channel on a periodic basis; and
predicting a future CQI value based upon the sequence of CQI values using one of a root method or a gradient method.

35. The tangible storage medium of claim 34, wherein the tangible storage medium has processor-executable software instructions configured to cause a processor to perform further steps comprising:
applying the future predicted CQI value to adjust HSDPA scheduling, including determining a packet size and appropriate network resource to a mobile device, wherein said obtaining a sequence of CQI values comprises periodically receiving determined CQI values from the mobile device.

36. The tangible storage medium of claim 34, wherein the tangible storage medium has processor-executable software instructions configured to cause a processor to perform further steps comprising:
transmitting the predicted future CQI value to a base station, wherein said obtaining a sequence of CQI values comprises periodically determining the CQI of the communication channel between the base station and a mobile device.

37. The tangible storage medium of claim 34, wherein the tangible storage medium has processor-executable software instructions configured to cause a processor to perform further steps comprising:
reducing estimation inaccuracy and quantization noise.

38. The tangible storage medium of claim 34, wherein the tangible storage medium has processor-executable software instructions configured to cause a processor to perform further steps comprising:
calculating a future CQI value using an adaptive filtering algorithm.

39. The tangible storage medium of claim 38, wherein the adaptive filtering algorithm comprises a one-tap adaptive filtering algorithm.

40. The tangible storage medium of claim 39, wherein the one-tap adaptive filtering algorithm comprises a one-tap minimum mean-squared error (MMSE) adaptive filtering algorithm.

41. The tangible storage medium of claim 40, wherein the one-tap MMSE adaptive filtering comprises a root method.

42. The tangible storage medium of claim 34, wherein the tangible storage medium has processor-executable software instructions configured to cause a processor to perform further steps comprising minimizing the equation:
E{|(1−α(n))\hat{μ}(n)+α(n)μ(n)−μ(n+K)|²}, with respect to α(n), where
$$α ( n ) = \frac{p ( K , n ) + \hat{p} ( 0 , n ) - q ( o , n ) - q ( K , n )}{\hat{p} ( o , n ) + p ( o , n ) - 2 q ( 0 , n )} .$$

43. The tangible storage medium of claim 40, wherein the one-tap MMSE adaptive filtering comprises a gradient method.

44. The tangible storage medium of claim 43, wherein the tangible storage medium has processor-executable software instructions configured to cause a processor to perform further steps comprising minimizing the equation:
E{|(1−α(n))\hat{μ}(n)+α(n)μ(n)−μ(n+K)|²},
with respect to α(n), where α(n+1)=[α(n)−2μ((\hat{μ}(n)−μ(n))(\hat{μ}(n−K)−μ(n−K)))]₀¹, and where [.]₀¹ denotes mapping to the interval [0,1] and where μ is a stepsize for α(n) update.
